(19) United States
(12) Patent Application Publication
(10) Pub. No.: US 2014/0336922 A1
(43) Pub. Date: Nov. 13, 2014

(54) Navigation Method And System With Route in Successive Windows

(71) Applicant: Pierre Hayot, Clermont-Ferrand Cedex (FR)

(72) Inventor: Pierre Hayot, Clermont-Ferrand Cedex (FR)

(21) Appl. No.: 14/345,166

(22) PCT Filed: Sep. 14, 2012
(86) PCT No.: PCT/IB2012/001831

§ 371 Date: Jun. 2, 2014

(30) Foreign Application Priority Data
Sep. 15, 2011 (FR) 1102794

(51) Int. Cl. G01C 21/36

(52) U.S. Cl. CPC G01C 21/3667
USPC 701/410

(57) ABSTRACT

Navigation system (1) comprising access to roadmapping data (19), at least one microprocessor (11), at least one working memory (18), a route calculation module (13), and furthermore comprising: a navigation window generation module (14), enabling the route data to be formatted into a plurality of successive fixed windows, each corresponding to one or more route instructions; a window-changing data generation module enabling data to be generated which are capable of permitting an automatic passage from one navigation window to another; a navigation module (43), to provide the transmission to the user of the successive navigation windows; a window-changing module (47), enabling the passage from one window to another according to window-changing data.

### TECHNICAL FIELD OF THE INVENTION

The present invention relates to a navigation system comprising access to roadmapping data, at least one microprocessor, at least one working memory and a route calculation module. The invention also provides a corresponding navigation method.

### PRIOR ART

Navigation methods and systems operating with the aid of mobile devices are well known and have even become commonly used tools for a considerably large number of road users.

For a number of years, commercially available navigation devices have comprised relatively small screens, but present an ever-increasing quantity of data. Users are fond of devices provided with presentations simulating the point of view of a driver on the road. Effects of realism and image quality furthermore attain particularly high levels.

Conversely, the quantities of data to be stored, processed and displayed have increased dramatically. However, despite all these enhancements, the accuracy of the presented routes or the ease of reading has not progressed. In fact, the widespread use of display methods with a scrolling mapping background with highly realistic colour images has helped to make usage more pleasant or attractive, but without simplifying the reading or understanding of the displayed data. The aesthetic and attractive side of the current devices furthermore creates a distracting effect for the driver.

Furthermore, most of the current devices are stand-alone and non-communicating, and therefore comprise all of the useful mapping data for calculating routes and displaying maps on which the routes are shown. Given the substantial quantity of data to be processed and retained, these devices require substantial capacities in terms of both memory and the microprocessor used. In addition to their complexity and high cost, this type of device has the disadvantage of containing data which quickly become outdated if no update is carried out. Finally, a stand-alone device cannot in any case supply data which have a very short life, such as, for example, traffic-related data.

To avoid these disadvantages, some suppliers have developed centralised systems in which a central server performs the route calculations for a huge community of users. The data, furthermore comprising roadmaps, are then transmitted from the server to the mobile device. An implementation of this type entails the exchange of substantial volumes of data, incompatible with a bandwidth which is very limited for each receiver, in particular at certain locations or times. Furthermore, the display of the route in the form of a roadmap with a large quantity of information has the disadvantage of burdening the user too intensely, often in order to obtain information which is irrelevant with regard to the route to be followed.

The document US 2004/117108 describes a navigation system in which the road to be followed is divided into segments sequentially transmitted to a mobile navigation terminal on the basis of segments calculated in the route server. The transmissions are carried out at given points of the calculated route. Subsequent segments are transmitted when a given point of a preceding segment is reached. The system described involves the transmission of segment data in addition to the specific- point data. These segment data help to increase substantially the quantity of data having to be transmitted from the server to the mobile devices.

The document US 2009/112462 describes a navigation system in which the route guidance list is prioritised in such a way that the information concerning the manoeuvring actions at the places nearest to the position of the user is given priority. For example, in the route guidance list, the information relating to the immediate manoeuvring location is more detailed, expanded and highlighted in relation to the other information. To transmit the information to the user, the method uses a list of manoeuvres.

The document US 2003/078729 describes a navigation system in which the road guidance information is suitable for use on a small screen. Road guidance information display elements are associated with numeric keys in increasing numerical order using hyperlinks. Each file is divided up in such a way that each element does not exceed the intended size of the file. The system presented involves an alternation of continuities displayed sometimes before, sometimes after an instruction. This non-constancy of the display mode constrains the user to adapt each time the mode changes, causing great confusion and hindering the speed of interpretation of the data.

The document U.S. Pat. No. 5,544,060 describes a navigation system for a vehicle enabling a user to obtain an optimum route between a departure point and a destination, before departure. Once the optimum route has been calculated, a pre-visualisation function enables the user to visualise the calculated route either before departure or at any point along the optimum route. The approach presented in this document involves only the distance to the next manoeuvre, with no notion of continuity.

Thus, in a general manner, the existing methods are not ergonomic and generally make intensive use of memory capacity, storage capacity and data-processing capacity.

The invention provides different technical means to overcome these different disadvantages.

DESCRIPTION OF THE INVENTION

A first object of the invention consists in providing a navigation system and method with optimised ergonomics, simplifying understanding and use, in all reliability.

A different object of the invention consists in providing a navigation system and method which simplifies the reading and understanding of the route data.

A different object of the invention consists in providing a navigation system and method which reduces the sources of distraction of the driver of a vehicle equipped with such a device.

A different object of the invention consists in providing a navigation system and method enabling operation with very little data in the mobile device.

A different object of the invention consists in providing a navigation method enabling the provision of constantly and regularly updated data.

A further different object of the invention consists in providing a navigation method enabling the provision of useful information in real time, even when the bandwidth available for a receiver is very limited.

To do this, the invention provides a navigation system equipped with a mobile navigation device comprising access to roadmapping data relating to at least one given geographical zone and enabling a plurality of routes to be determined in this zone, at least one microprocessor, at least one working memory, a route calculation module, and furthermore comprising:

a navigation window generation module, enabling the route data to be formatted into a plurality of successive fixed windows, each comprising a continuity indication corresponding to the display of the current road and the distance over which this road must be followed and a continuity change instruction in the form of either direction data to be followed or manoeuvring geometry data;
a window-changing data generation module enabling data to be generated which are capable of permitting an automatic passage from one navigation window to another;
a navigation module, to provide the transmission to the user of the successive navigation windows;
a geolocation module, enabling the real position of the mobile navigation device to be determined during the movement of the latter;
a matching module, enabling a correspondence to be established between the real position supplied by the geolocation module and the intended route;
a window-changing module, enabling the passage from one window to another according to window-changing data.

A system of this type enables the route data to be formatted in a particularly compact manner, by retaining only the data which are really useful for understanding and following the route. Furthermore, the preparation of the routes in the form of successive navigation windows enables a considerable reduction in the memory capacity and power required to transmit, store and/or use the route data. Thus, a greater number of devices, even low-powered devices, are capable of carrying out the method. The use of navigation windows instead of roadmaps helps to simplify the reading and understanding of the instructions to travel the route. Finally, for an implementation with a server, an implementation of this type furthermore enables numerous and frequent exchanges between a server and a plurality of mobile navigation devices without resulting in a heavy consumption in the communication networks used.

The removal of the conventional roadmap and its replacement with directional elements and geometric representations of the relevant sections enable a particularly pared down representation of the route to be obtained. For the user, who is not looking for a faithful representation of the physical reality, but rather an easy-to-interpret directional guide, a synthetic route such as the one proposed results in few or no disadvantages. Furthermore, a very large part of the mapping details presented on the detailed maps is imperceptible from the vehicle when following the route. The removal of these details does not therefore interfere with the following of the route when the vehicle moves.

The window-changing data generation module advantageously determines, for each window, at least one window-changing point capable of being recognised during the progression along the route.

The window-changing point advantageously corresponds to a geolocation point.

According to one advantageous embodiment of the invention, the system furthermore comprises a manoeuvring point detection module, provided to identify the manoeuvring points along the route.

According to a further different advantageous embodiment, the system comprises a direction data availability testing module, provided to check, for each identified manoeuvring point, whether direction-following data are provided in the available roadmapping data.

According to one advantageous embodiment, the navigation system comprises a centralised server having access to roadmapping data relating to at least one given geographical zone and enabling a plurality of routes to be determined in this zone, and a plurality of mobile navigation modules, capable of communicating at least temporarily with the central server to exchange data. In one advantageous alternative, the digital roadmapping data are retained in the server (internally or externally). This allows the updates to be centralised in such a way that the mobiles can easily have the most recent data at their disposal.

According to one advantageous alternative, the route calculation module, and possibly the navigation window generation module, and possibly the window-changing data generation module, are provided in the server. The module centralisation being capable of requiring substantial processing capacities enables the provision of high-performance hardware in keeping with the requirements of the system users.

According to a further alternative embodiment, the navigation system furthermore comprises a direction data availability testing module to check, for each identified manoeuvring point, whether direction-following data are provided in the available roadmapping data (advantageously in the server, but may also be in the mobile navigation modules).

The invention also provides a navigation method for a navigation system comprising at least one mobile navigation device and having access to digital road mapping data relating to at least one given geographical zone and enabling a plurality of routes to be determined in this zone, comprising the following steps:

receiving data enabling a route to be determined;
calculating, with the aid of a route calculation module and mapping data of at least one zone, at least one route on the basis of the received data;
arranging, with the aid of a navigation window generation module, the route data into a plurality of successive fixed windows, each comprising a continuity indication corresponding to the display of the current road and the distance over which this road must be followed and a continuity change instruction in the form of either direction data to be followed or manoeuvring geometry data;
displaying, with the aid of a display module of the mobile navigation device, the successive navigation windows.

The data relating to the continuity indication, the given distance and the route-following instruction are advantageously arranged or formatted in such a way that the display of these data takes up the largest portion of the display space available on the display screen.

The fact of using very concise route data enables a great flexibility in the methods of presentation to the user. The route data can easily be presented on a screen (even of small size), projected onto the windscreen of a vehicle, or with the aid of spectacles serving as a projection medium, by voice synthesis, etc.

The route data comprise the essential elements for following the route. The removal of numerous visual elements of a purely aesthetic nature simplifies the reading, avoids any distraction of the driver/user, and thus helps to improve road safety.

According to a first alternative embodiment, the successive navigation windows are displayed according to the real position of said device.

According to a different alternative embodiment, at least one window-changing datum (geolocation indicator) is provided for each of the navigation windows in order to display the window in relation to the current position of the mobile concerned. As required, the continuity indication may be arranged before or after the instruction.

As required, an instruction comprises a direction datum to be followed (for example sign or sign extract) or a manoeuvring pattern. In one advantageous example, if a direction datum exists in the mapping data, the instruction comprises the direction datum (town, region, exit number, road, cardinal point, etc.), otherwise the instruction comprises a manoeuvring pattern.

The guidance method according to the invention is provided with fixed windows, unlike the well-known and widespread dynamic guidance mode, in which a rolling or scrolling mapping background progresses gradually, generally from the top to the bottom of the screen in such a way as to represent the progress of the vehicle along the route. The term “fixed” means that the displayed elements do not comprise any animation or movement. Thus, the data such as the numbers and/or letters displayed change value, but do not change position on the screen.

For the route portions for which a direction indication is available in the roadmapping data, the extracted direction data enable the creation of particularly pared down navigation windows, without the mapping conventionally used to present the route. Guidance data which are quickly perceptible by the user, simple to interpret, and with a practical implementation offering high reliability are thus obtained, due to the fact that the user instinctively follows the directions according to the names of places or sites readily visible on the road signs present along the route. Moreover, the direction data are numeric data generally requiring a few kilobytes only. The corresponding data files therefore require a considerably smaller memory space than conventional route files comprising mapping data (generally in the form of map images) of the entire zone or region or route travelled. Reduced-data route files of this type can easily be managed from a centralised server, then transmitted via a non-wired network to a very large number of mobiles travelling on the corresponding road network, without involving an excessive consumption of the technical resources of the data transfer network.

In one alternative embodiment, the windows comprise a schematic representation of the route portion corresponding to the window (drawing comprising a line schematically illustrating the path or straight line).

The matching between the coordinates received from a geolocation device and the route is preferably carried out in such a way as to indicate, on the windows of the successive steps, the position of the mobile navigation device on a schematic representation of the route.

In an advantageous manner, the schematic representations of the route portions of the navigation windows are multi-scale with possible deformations of certain sections in relation to the original mapping representation.

According to one advantageous embodiment, the navigation system comprises at least one centralised server and a plurality of mobile navigation devices capable of communicating at least temporarily with the central server to exchange data. In such a case, the digital roadmapping may be retained in the centralised server.

Still according to this embodiment with a server, the route calculation, navigation window generation and window-changing data generation steps are advantageously provided in the centralised server with dispatch to the mobile navigation device concerned, with the aid of data exchange modules, of the navigation window data and the possible window-changing data.

According to a different embodiment, the mobile navigation devices are stand-alone and do not require communication with a server to carry out the steps previously described. In such a case, the mobile devices have all of the modules required for the route calculation, window and window-changing data generation, etc., locally at their disposal.

The invention finally provides a computer program product intended to be loaded into a memory associated with a processor, the computer program product comprising portions of software code carrying out the previously described method when the program is run by the processor.

### DESCRIPTION OF THE FIGURES

All the implementation details are given in the description which follows, supplemented by FIGS. 1 to 14, presented only as non-limiting examples, and in which:

FIG. 1a is a schematic representation of a centralised navigation system according to the invention;

FIG. 1b is a schematic representation of a stand-alone mobile navigation system according to the invention;

FIG. 2a is a functional flow diagram showing the main steps of a centralised navigation method according to the invention;

FIG. 2b is a functional flow diagram showing the main steps of a decentralised navigation method according to the invention;

FIG. 3 is a functional flow diagram, complementing that of FIGS. 2a and 2b, showing additional steps of a preferred embodiment of the invention;

FIGS. 4 and 5 show examples of navigation windows according to the invention;

FIGS. 6 to 14 show examples of route data in the form of navigation windows for a route between Mantes la Ville and Arcangues.

### DETAILED DESCRIPTION OF THE INVENTION

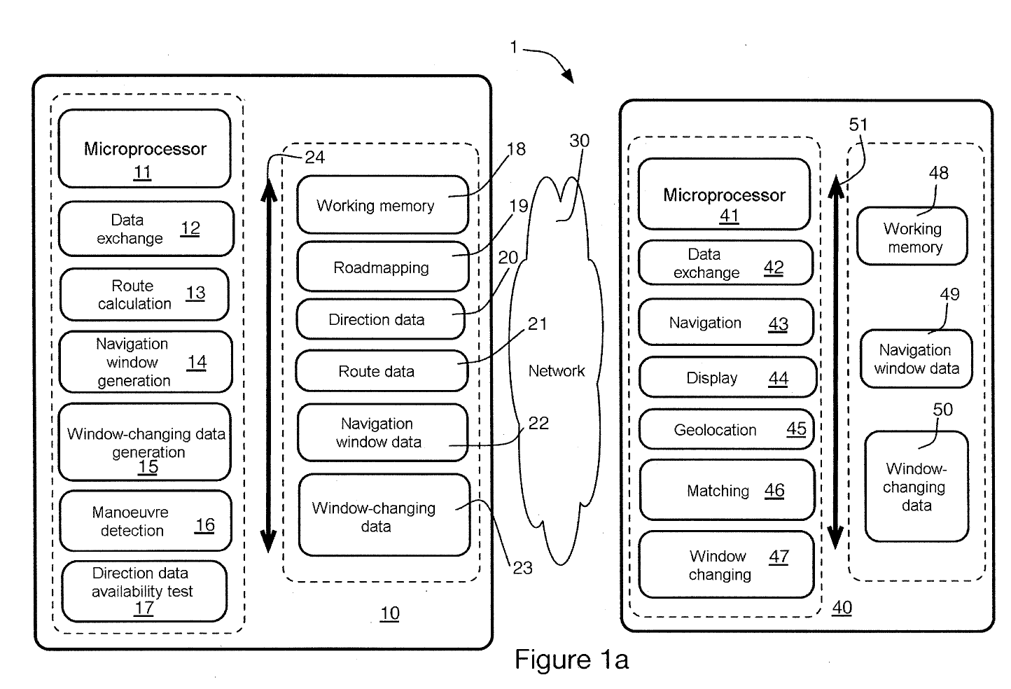

FIG. 1 shows an example embodiment of a navigation system 1 according to the invention. It shows, on the one hand, a route server 10, provided to generate all the data relating to the route for which a route must be produced and navigation carried out. The route server 10 comprises at least one microprocessor 11, for the execution of processor instructions or specifically provided commands, a data exchange module 12, capable of receiving and transmitting data with a plurality of mobile navigation devices 40. Furthermore, the data exchange module 12 enables the reception of route requests from mobile navigation devices 40 with departure and arrival point data, and the transmission to a mobile navigation device 40 (or the requesting device or one or more other devices) of the data produced by the server 10. A means of communication, transfer or data exchange or command, for example a bus 24, is provided to perform the required exchanges between the microprocessor 11 and the different modules.

The route server 10 comprises a route calculation module 13 operating in a manner known per se, with the aid of an algorithm for determining the shortest path between two points, such as Dijkstra or the like. An algorithm of this type, with the aid of a microprocessor and the required processor instructions, enables the exploration of a very large number of possibilities (from several tens or hundreds for low-density zones and/or for short routes, to several hundreds of thousands, or more, for high-density zones of routes and/or for long routes) with the aim of choosing an optimum route according to given criteria, such as the shortest route, or the fastest route etc.

Once the route is known, a manoeuvring point or instruction point detection module 16 enables the manoeuvring points along the route to be detected, i.e. the points or zones where manoeuvres must be carried out to enable the intended route to be followed. A manoeuvre is mainly understood to mean a vehicle-driving action enabling a different section to be selected or not when the driver is faced with a possibility of committing his vehicle to a plurality of sections (at least two). The driver is faced with multiple possibilities for continuing his route, and a manoeuvre enables him to commit his vehicle according to the direction intended by the pre-established route. Thus, the module 16 travels a virtual path of the route produced by the module 13, and identifies the points or nodes where multiple sections are joined. It may involve an intersection of routes, exits or entrances on motorways, and junctions, etc. The manoeuvring points are determined in a manner known per se. For a roundabout, it is understood that a plurality of simple manoeuvres are generally involved, from the entry to the roundabout, then to the passing of each exit, each time involving a manoeuvre consisting either in remaining on the roundabout or leaving it, until the actual exit from the roundabout. In the present document, roundabouts are considered as a single manoeuvre, of the “take the 3^{rd} exit” type, actually consisting in a complex manoeuvre, as previously described, or of the “turn left” type, considering the entire roundabout as a single intersection of a plurality of roads.

The route server 10 also comprises a navigation window generation module 14 designed to generate a succession of windows comprising navigation data corresponding to instructions capable of enabling the route to be followed in a reliable manner. The windows are generated from the direction data to be followed and/or geometry data of manoeuvres or manoeuvring patterns. The data are arranged according to the order of the manoeuvres to be carried out in order to travel the previously calculated route.

In one preferred embodiment of the invention, the route data are disposed according to a plurality of successive fixed windows each comprising a continuity indication associated with a given distance and a route-following instruction.

The distance may be expressed in various ways, such as, for example, by a duration, a distance, a datum relating to the distance or gap between the navigation device and the next instruction, etc. An instruction is presented either by means of direction data to be followed, or by geometry data of manoeuvres or manoeuvring patterns.

The route server 10 furthermore comprises a direction data availability testing module 17. This direction data testing module 17 is designed to check, in the roadmapping databases 19, the manoeuvring points for which direction data to be followed are available in the database. These data mean, for example, that one or more road signs indicating a relevant direction are present along the route concerned. This test is preferably carried out upstream of the route generation, in order to enable a specific processing according to the results of the test. Thus, if direction data are available, they are used to make up the navigation windows. If no direction datum is available for one or more manoeuvring points, the method provides, for these manoeuvring points, a step of geometric reconstruction of the useful sections illustrating the manoeuvres allowing the route to be followed.

In order to carry out the test, the direction data testing module 17 reviews all of the manoeuvring points detected for a given route in order to determine whether the roadmapping data do or do not include direction data to be followed. In practice, these data are often presented for the major arterial roads such as the motorways or national roads. They may be available in a more substantial manner if they are obtained by an automatic image processing system capable of recognising the signs in order to extract the data from them, on the basis of panoramic photographs captured in a systematic manner by specially equipped vehicles, or by other equivalent means. The fact that the direction data test is carried out by the server allows all users to benefit from centralised updates of the roadmapping databases.

When a plurality of direction indication possibilities exist, it is preferably provided to prioritise the direction most in-phase with the route, i.e. a direction corresponding to a location through which the route passes or close to which the route passes and which is the most distant on the route among the potential locations. In a different embodiment, if the information is available, the most known direction is retained. In a further different embodiment, the direction which is the shortest to write is retained. In a different variant, in the absence of signs, if the next road passes through one or more localities, the most distant locality through which the route passes is retained.

The availability testing module takes action in a distinct manner, according to the results of the tests carried out. Thus, if direction data are available, these data are extracted in order to generate navigation windows. If direction data are not available, the availability testing module constructs, on the basis of the roadmapping data, a geometric model of the road sections to be covered to travel the route. Thus, specific route elements are obtained according to the results of the tests carried out by the direction data availability testing module.

In one alternative embodiment, the availability testing module uses pre-designed pictograms to represent schematically the manoeuvres for which the directions to be followed are not available.

In a different alternative embodiment, when the direction is known and the space on the screen is limited, the direction is displayed at the expense of the manoeuvring pattern, otherwise the manoeuvring pattern is displayed. In a different alternative, if no direction data are available, only the next path is indicated.

The route server 10 furthermore comprises a window-changing data generation module 15. When these data are used by a mobile navigation device 40, they enable it, without the need to have all of the points and/or sections of the route, to validate the passage over or near to window-changing validation points. These points are provided in such a way that the windows succeed one another in an ordered manner, advantageously in a manner coordinated with the progression of the mobile device along the route, so that the currently displayed windows correspond optimally to the instructions to be followed and the current continuity data.

The data used by the route server 10 advantageously originate from a roadmapping module or database 19 provided within the route server 10 as shown in the example illustrated, or at a location outside the server which the latter can access if required. Similarly, the routes produced by the server can be retained in a module or database of produced routes 21, provided within the server 10 as shown in the example illustrated, or at a location outside the server which the latter can access if required. The same applies to the direction data, the navigation window data and the window-changing data, which may be retained in modules or databases of directions 20, of navigation windows 22 and of window changing 23 respectively, provided within the server 10 as shown in the example illustrated, or at a location outside the server which the latter can access if required.

A route server 10 is designed to be in communication, for example via the intermediary of a cellular or other telecommunications network, according to requirements, with a plurality of mobile navigation devices 40. Each of the mobile navigation devices 40 has a data exchange module 42, designed to transmit route requests to a route server 10, and to receive in return the data produced by the server 10. The navigation devices 40 comprise, in addition to a microprocessor 41 and at least one working memory 48, a navigation module 43, to enable and manage the transmission to the user of the navigation windows received from a route server 10. This transmission is preferably provided by means of a display on a display module 44. According to the requirements and wishes of the user and/or implementation methods, the route windows may be visualised either prior to the actual implementation of the route on the route for information, or in manual mode, for example by the user scrolling through the windows, for example by sliding his fingers over a suitable touch screen, or in navigation mode with presentation of the data according to the real position of the vehicle. A means of communication, transfer or exchange of data or command, for example a bus 51, is provided to perform the required exchanges between the microprocessor 41 and the different modules.

The mobile navigation device 40 furthermore comprises a geolocation module 45 and a matching module 46 suitable, on the one hand, for receiving the position data from the mobile navigation device 40 and, on the other hand, for establishing a correspondence between the raw position data received from the geolocation device and the positions assigned to the manoeuvring points and/or to the window-changing points.

A window-changing detection module 47 enables the mobile navigation device 10 to present a display window-by-window, in a successive manner, without movement or scrolling of a mapping background or the like. The window-changing module preferably uses window-changing data, generated at the time when the navigation windows are obtained, in order to manage the passage from one window to another according to useful points, such as points located at the edge of a zone covered by a window. In practice, when a mobile navigation device moves over or near to such a point, a passage validation enables the passage to the following window to be generated.

In the example embodiment shown in FIG. 1, the data received from a route server 10 by a mobile navigation device 40 are stored in dedicated memory modules or bases, i.e. a navigation window data module 49 and a window-changing data module 50.

FIG. 1b presents an alternative embodiment in which the mobile navigation devices operate in stand-alone manner. A device of this type thus comprises all of the modules previously described in relation to the server 10 (i.e. the microprocessor 11, route calculation 13, navigation window generation 14, window-changing data generation 15, manoeuvre detection 16, direction data availability testing 17, working memory 18, roadmapping 19, direction data 20, route data 21, navigation window data 22 and window-changing data 23 modules) except the data exchange module 12. It furthermore comprises the following modules, previously described in relation to the mobile navigation device 1, i.e. a navigation module 43, display module 44, geolocation module 45, matching module 46, and a window-changing module 47. All of the modules operate locally, without having to carry out a data transfer between a server and a mobile navigation module. A device of this type has the advantage of being stand-alone, independent of the availabilities of the communication networks. The route data displayed in the form of fixed windows enable this device to offer users excellent readability, optimum ergonomics, and a removal of sources of animation, such as the scrolling of a roadmapping background, which are a substantial source of loss of attention of the driver.

The different server modules 10 and mobile navigation devices 40 previously described are advantageously implemented by means of processor instructions or commands, enabling the modules to perform the operation(s) specifically intended for the module concerned. The processor instructions may be in the form of one or more software programs or software modules implemented by one or more microprocessors. The module(s) and/or software program(s) are advantageously provided in a computer program product comprising a recording means or recording medium usable by a computer and comprising a programmed code readable by a computer integrated into said means or medium, enabling application software to run on a computer or other device comprising a microprocessor such as a navigation device.

According to various alternative embodiments, the microprocessors 11 and 41, just as the working memories 18 and 48, may be centralised for all the modules of the route server 10 or mobile navigation device 40, or may be disposed in an external manner, with connection to the different modules, or may be distributed locally in such a way that one or more modules each has a microprocessor and/or a working memory.

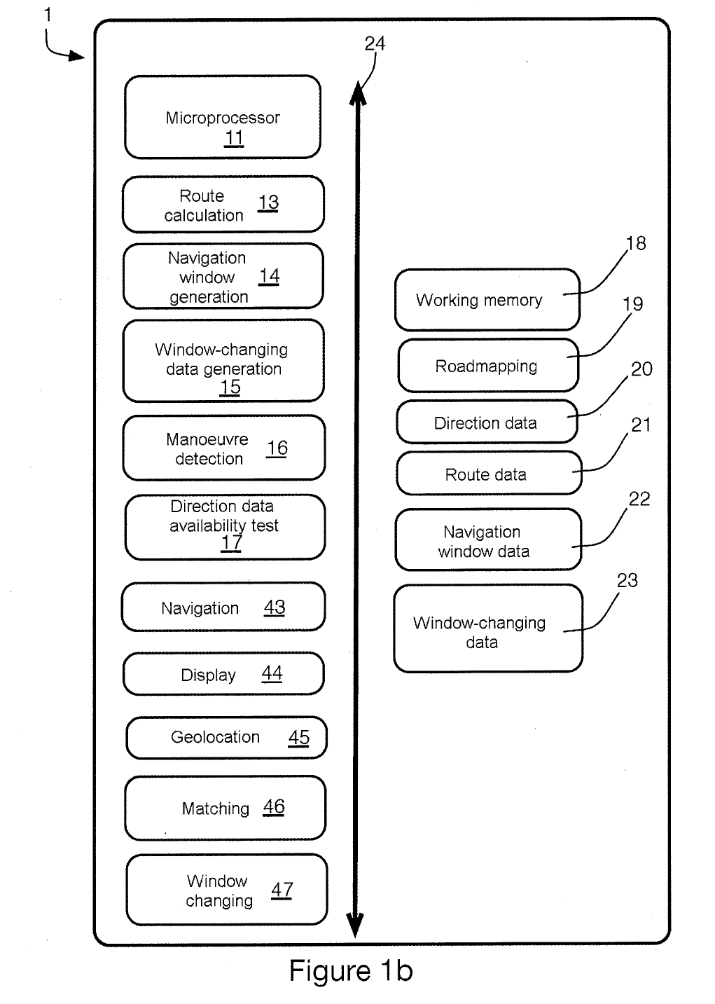

FIG. 2a shows successively the main steps of the method according to the invention for the case where a server 10 is used for the implementation. In step 101, the server 10 receives a route calculation request. For example, a user of a mobile navigation device 40 sends a request to the server to which it is connected. The request advantageously comprises data relating to the departure point and the arrival point. These data may also be standardised or already stored by the server. A request may also originate from a third-party manager of routes to be travelled by one or more users.

In step 102, the route is calculated by the route calculation module 13. As shown in FIG. 2, this step also comprises a part in which the manoeuvring point detection module 16 identifies the manoeuvring points allowing the previously calculated route to be travelled, as previously described in relation to the module 16.

Step 103 provides the formatting of the route data into a plurality of successive fixed windows. “Fixed windows” is understood to mean windows displayed in a static manner, without rolling or scrolling, for example, from the top to the bottom of the screen as conventionally used to simulate or represent the movement of the vehicle. The content of the navigation windows is previously described in relation to the navigation window generation module 14.

In step 104, the window-changing data are obtained and possibly stored in the window-changing data module 23. These data are described above in relation to the window-changing data generation module 15.

In step 105, the data exchange module 12 of the server carries out the dispatch of the useful data to the corresponding mobile navigation device. These data comprise, on the one hand, the navigation window data, and, on the other hand, the window-changing data. The mobile navigation device receives these data in step 106. Then, in step 110, when the mobile navigation device 40 travels the path along the route, the successive navigation windows are presented according to the real position of the device along the route (step 111). The passage from one window to another can also be implemented by stimulation or manually.

In step 112, which takes place during the period of travelling the route, the window-changing module 47 of the mobile device carries out a monitoring, on the one hand, of the progression of the mobile navigation module along the route and, on the other hand, of the window-changing points. During the validation of a window-changing point, the window-changing module ensures the passage to the following window. The validation is carried out when the mobile navigation module passes in the immediate proximity of a window-changing point. In various alternatives, the window-changing points are replaced by zones, sectors, or by a plurality of points.

FIG. 2b shows an alternative embodiment of the method corresponding to a hardware architecture in which the mobile navigation devices can operate without exchanging data with a server. In such a case, steps 105 and 106 of FIG. 2a relating to the data transfers between the server and the mobile navigation devices for the transmission and reception of window data and window-changing data are removed. The other steps are similar to those presented in relation to FIG. 2a. In this type of implementation, all of the operations previously described in relation to the server 10 are carried out locally in the mobile navigation devices. Furthermore, the window generation and window-changing data generation operations are carried out locally, by each navigation device. Obviously, this does not exclude the optional use of a server for the performance of other tasks or the supply of other types of data, such as, for example, the supply of traffic information data.

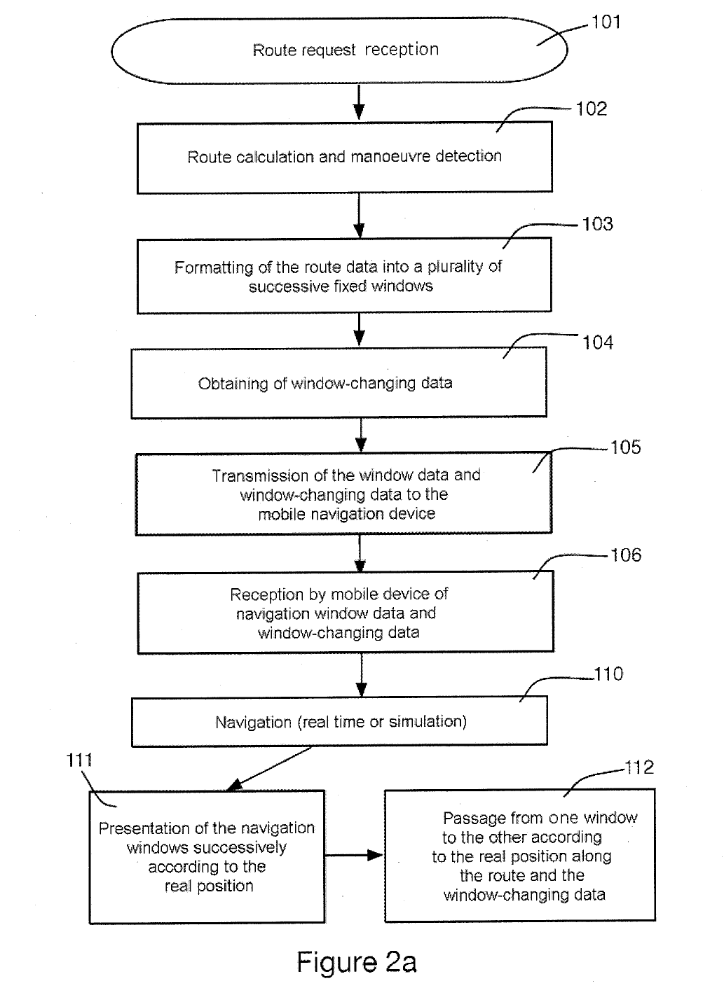

FIG. 3 shows the intermediate steps of the navigation method according to the invention. In step 200, the direction data availability testing module 17 checks the availability of direction data to be followed in relation to the manoeuvring points provided for travelling the route. In step 201, if direction data to be followed have been identified, the window(s) relating to this direction is/are formatted on the basis of these data. In such a case, the guidance instructions supplied to the user include the identified direction. The direction data may comprise information relating to the cardinal points. In step 202, if no direction data are identified, a pictogram or manoeuvring pattern is obtained for the corresponding window(s). Steps 200 to 202 advantageously take place between steps 102 and 103 presented in FIGS. 2a and 2b.

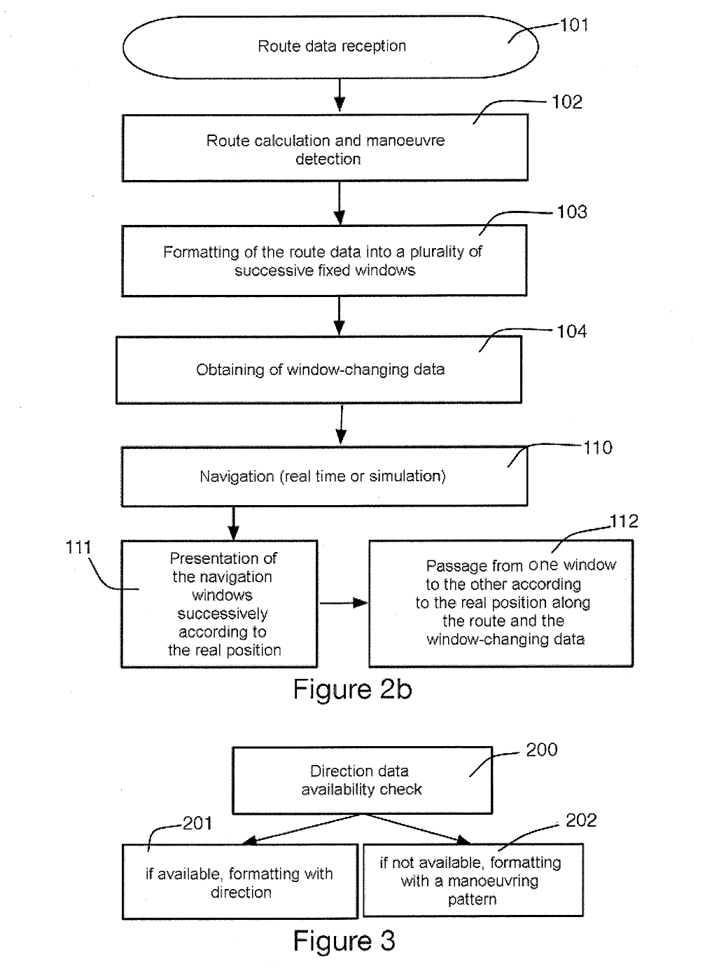

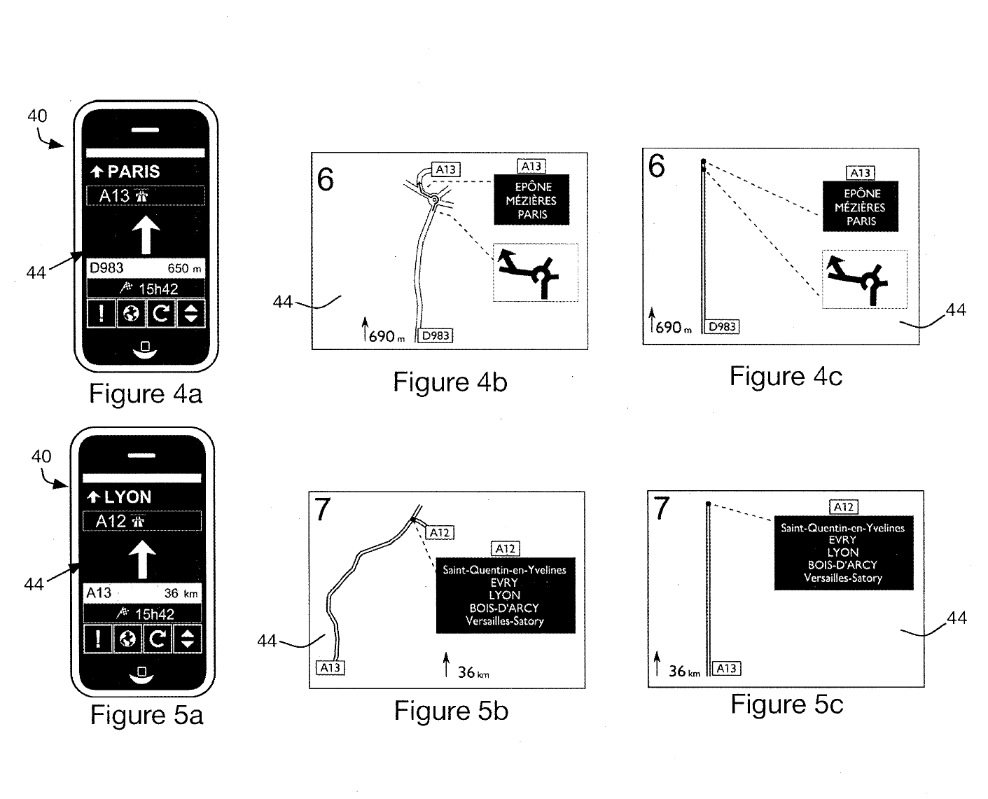

FIGS. 4 and 5 show display examples obtained by means of mobile navigation devices 40 suitable for the implementation of the present invention. The display module 44 displays the navigation window data. In the different examples shown, the route data are arranged into a plurality of successive fixed windows, each comprising a current road indication in association with a given distance and a route-following instruction. Thus, for example, FIGS. 4a and 5a show navigation window examples in which direction data to be followed can be seen in the upper zone of the display module. In the lower portion of the display module, data relating to the current road (name or number) are displayed, with a distance over which the road is taken before emerging onto a new road or performing a manoeuvre. In these examples, a straight arrow is displayed in the centre of the display zone to represent the action consisting in “continue” for the indicated distance. In these examples, the continuity is represented by the display of the current road and the distance over which this road must be followed. The straight arrow reinforces the continuity indication. In this case, the instruction corresponds to a direction to be followed, the A13 motorway, in the direction of Paris and the A12 motorway, in the direction of Lyon.

The term “continuity” does not necessarily mean that the road has no intersections, but rather that a natural continuity of the road, and therefore the absence of a change of direction or forking between branches of equal value, exist.

Such a simplification of the guidance instructions presented by the mobile navigation device allows the user not to be constantly troubled as soon as the road to be followed is curved, or for intersections with roads which are irrelevant to the route to be followed.

As shown in these examples, contextual data can also be displayed. This may involve, for example, data relating to:

safety: speed cameras, atypical speeds, dangerous bends, dangerous slopes;
services: hotels, restaurants, filling station, etc;
traffic and/or weather data;
“reassurance” data: close passage, work of art, etc.
tourism data: object to be pointed out on the route or to be suggested for a visit.

The aim of the reassurance data is to inform the user that the mobile device is continuing to progress correctly along the route. Thus, by indicating, for example, a passage close to a place or site that is known or visible from the road where the mobile device is moving, the user has confirmation information relating to the path followed.

When a plurality of changes of direction succeed one another at reasonably short intervals, they are advantageously aggregated into a single navigation window comprising a single pattern. The aggregation threshold is, for example, 3 seconds.

As shown in the examples in FIGS. 4a and 5a, the display module can also comprise data relating to the expected arrival at the destination. For example, the arrival data may include elements such as the number of kilometres to be travelled before arrival, the time remaining before arrival, the expected arrival time, etc. Other information, such as, for example, a possible delay or additional time linked to heavy traffic on the route, can also be displayed. The displayable elements may possibly be parameterisable by the user.

In the case of aggregated road changes, the pattern of the first manoeuvre to be performed is preferably followed by the name of the last road. This indicates how the complex manoeuvre is undertaken and the road to be taken at the end of the complex manoeuvre.

In the example shown in FIGS. 4a and 5b, the corresponding portion of the route to be travelled is illustrated in a schematic manner. The non-adherence to a particular scale enables paths of different lengths to be displayed on each of the windows, according to the manoeuvres. The windows are not therefore structured in relation to a fixed distance to be travelled, but according to the manoeuvres to be performed.

In the examples shown in FIGS. 4c and 5c, a more or less straight virtual route line is defined, with the instruction points distributed along the line. In such a case, the distance to be travelled between two instruction points is advantageously integrated schematically along the route line.

In FIGS. 5a, 5b and 5c, the user is informed that he is travelling on the A13 road which he must follow for 36 km by following the direction A12 EVRY-LYON-BOIS D'ARCY, up to the manoeuvring point consisting in taking the A12 road. These windows therefore each provide a continuity indication in association with a given distance and a route-following instruction: the continuity on the A13 motorway for 36 km, and an instruction indicating a continuity change to follow the A12 motorway in the direction of Lyon.

### Various Alternatives

The directions to be followed are advantageously presented with a view representing the visual appearance of the road signs which the user will easily be able to recognise when he is on the road, at the corresponding location. The directions can also be based on the names or numbers of roads, such as, for example, N230. Finally, the directions may also be based on exit numbers. A plurality of direction indications can be used in a simultaneous or complementary manner, such as, for example, the motorway A12 and Saint-Quentin-en-Yvelines, thus specifying the route and direction, A10 and Orléans, A63 and exit No 15, etc. The fact of associating a plurality of directional elements enables the user to visually recognise a plurality of signs, thus simplifying the following of the route. The user is furthermore comforted in his driving and avoids wondering unnecessarily whether he has or has not taken the right direction.

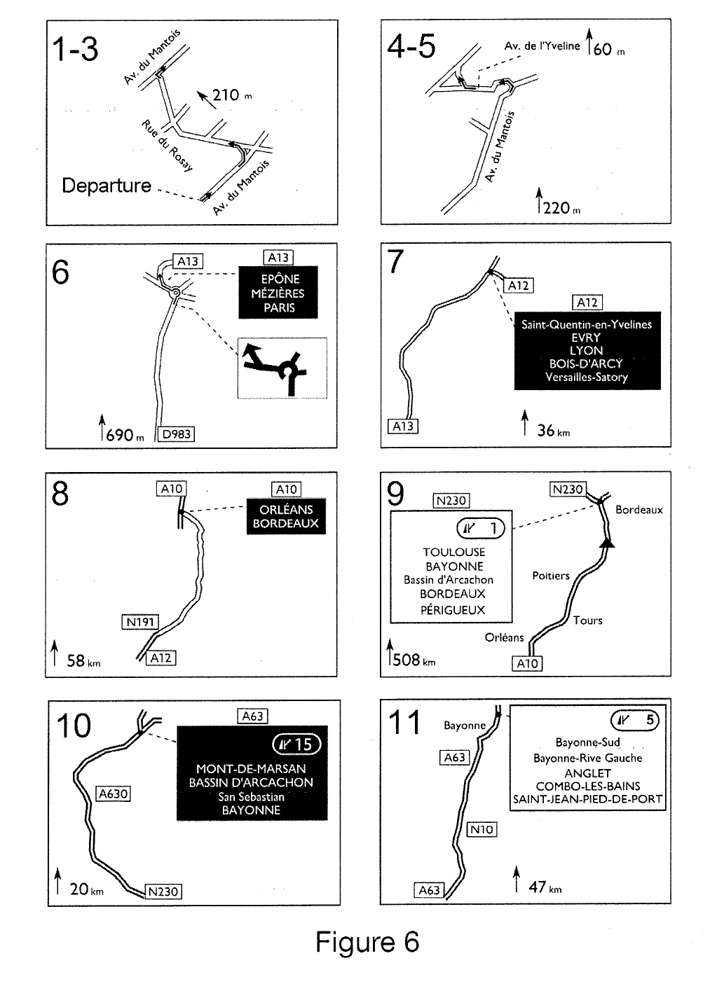

The examples shown in FIG. 6-image 9 and 8b-image 9 also include close passage data, such as Orléans, Tours, Poitiers, Bordeaux. These data do not form part of the data normally available in road databases. They are therefore supplied by way of reference, to enable the user to validate his progression along the route.

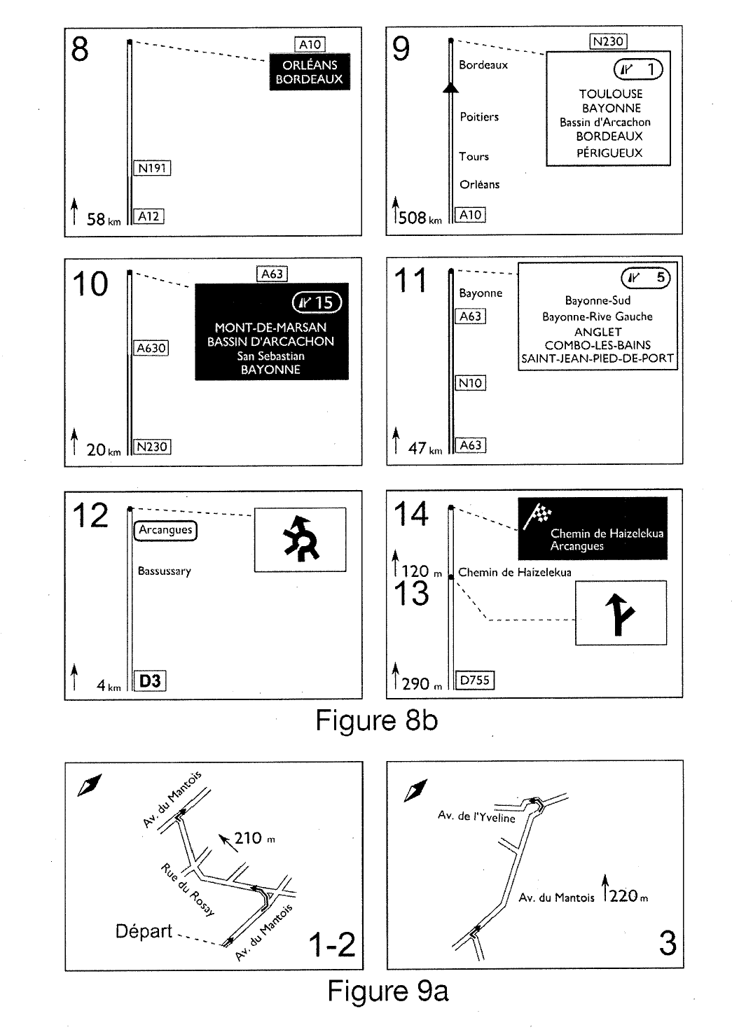

In the examples shown in the various figures, the reading direction of each of the windows is provided from the bottom to the top of the window, in such a way as to correspond to a representation of the route with the road in front of the vehicle. A representation of this type is very realistic and instinctive and therefore easy to interpret, even with a minimum of data. Moreover, an arrangement of this type corresponds to an increasingly widespread method, i.e. the visual representation used for GPS navigation devices. In one or the other of these alternatives, a mobile pictogram or point along the schematic road representation can be provided in order to represent the progression of the mobile navigation device along the route portion represented by the current window. Examples are shown in the windows of FIGS. 8b image 9 and 9b image 8 by a pictogram in the shape of a triangle.

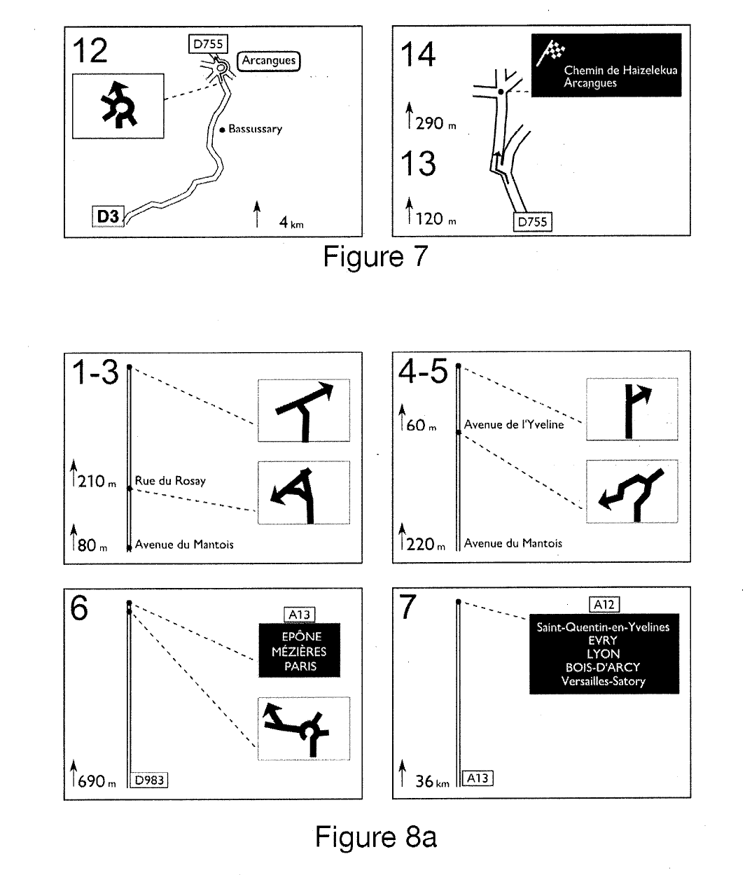

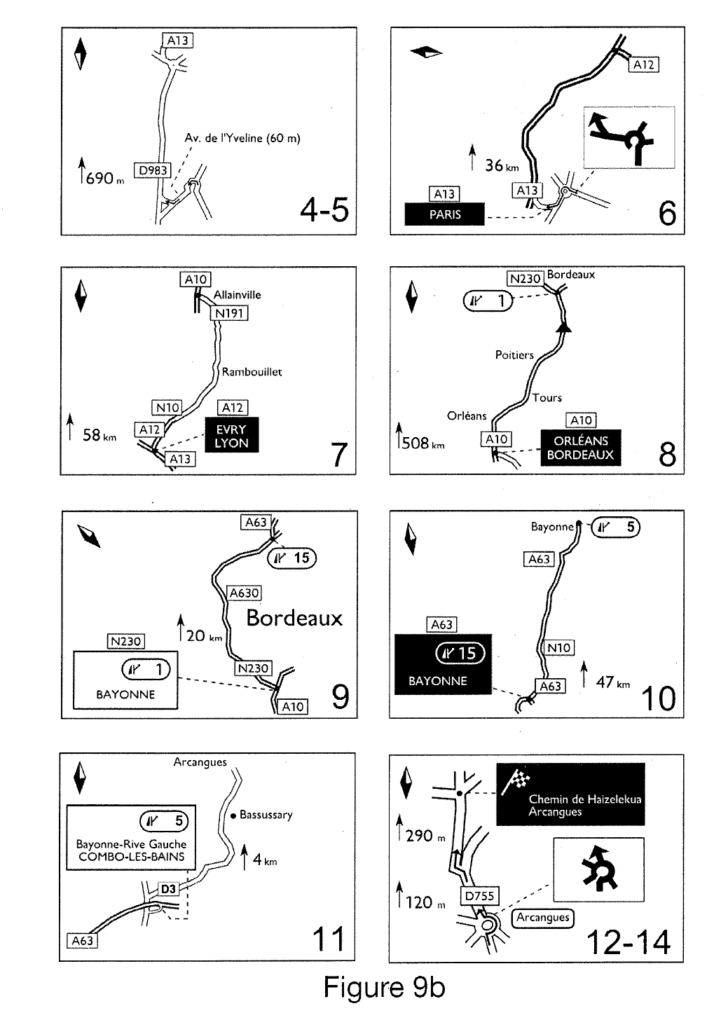

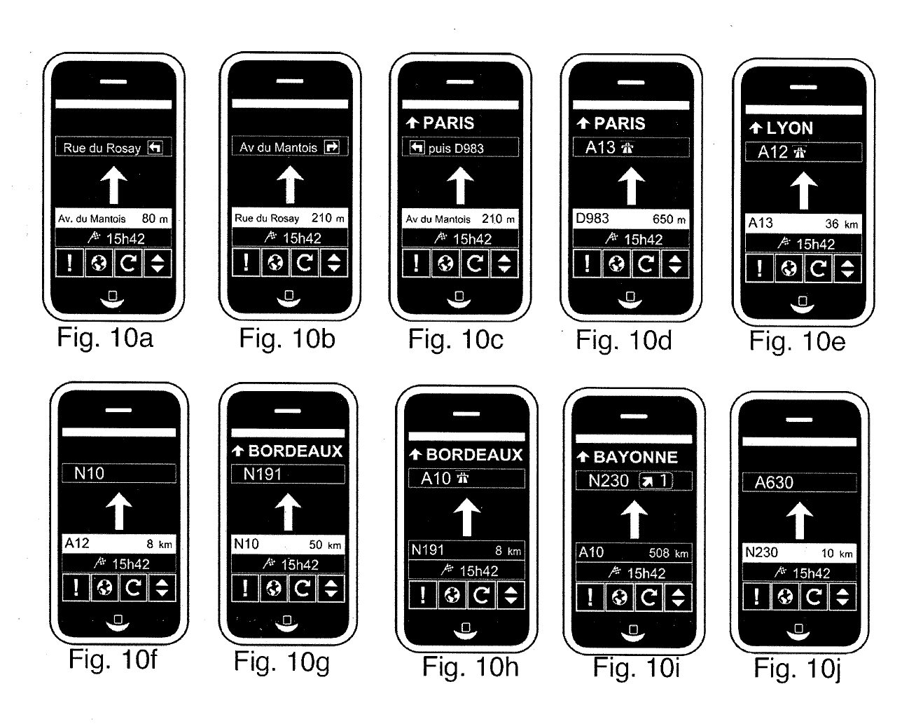

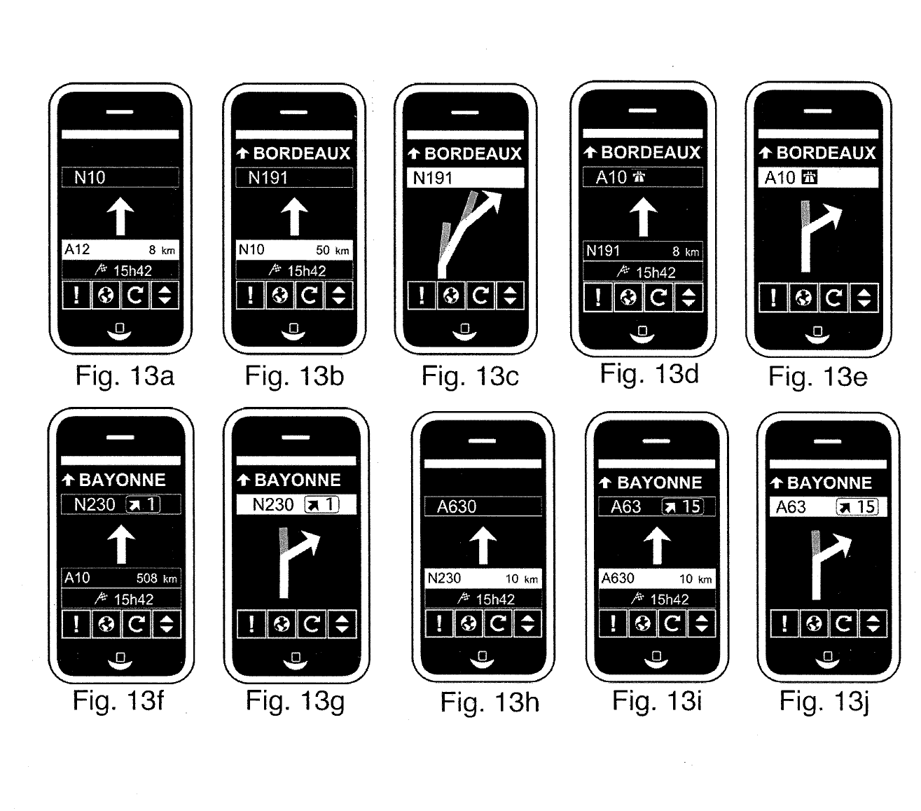

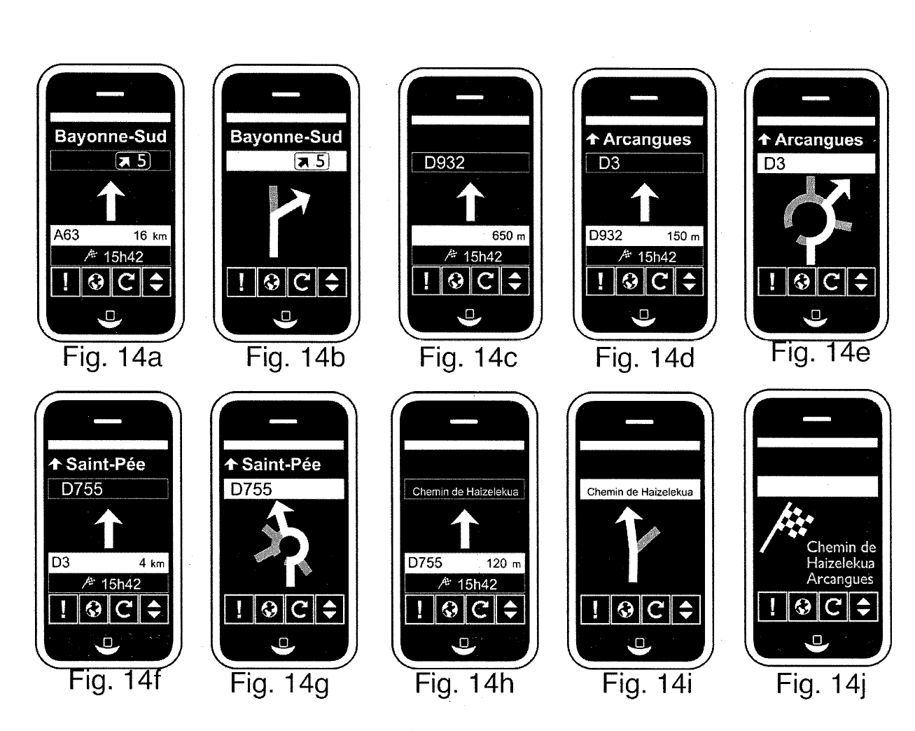

FIGS. 6 to 14 show various alternatives of windows for an example of a route between Avenue du Mantois in Mantes-la-Ville and Arcangues. The following instructions, for example, can be seen for the windows shown in FIGS. 10a to 10g:

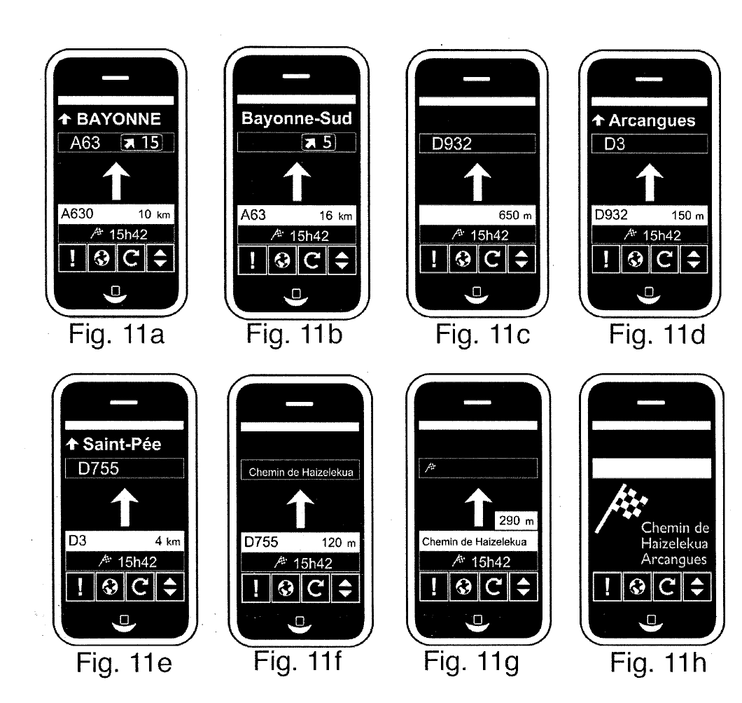

Window 1: “continue” for 80 metres on Avenue du Mantois, until a next instruction corresponding to a continuity change to Turn left into Rue d u Rosay (FIG. 10a);
Window 2: “continue” for 210 metres on Rue du Rosay , until a next instruction corresponding to a continuity change to Turn right into Avenue du Mantois (FIG. 10b);
Window 3: “continue” for 210 metres on Avenue du Mantois, until a next instruction corresponding to a continuity change to Turn left onto the D983 (FIG. 10c);
Window 4: “continue” for 650 metres on the D983, until a next instruction corresponding to a continuity change to take the A13 in the direction of Paris (FIG. 10d);
Window 5: “continue” for 36 km on the A13 until a next instruction corresponding to a continuity change to Take the A12 in the direction of LYON (FIG. 10e);
Window 6: “continue” for 8 km on the A12 until a next instruction corresponding to a continuity change and follow the direction for the N10 (FIG. 10f);
Window 7: “continue” for 50 km on the N10 until a next instruction corresponding to a continuity change to Take the N191 towards BORDEAUX (FIG. 10g).
The following FIGS. 10h to 11h show the remaining windows for this example of a route to Arcangues.

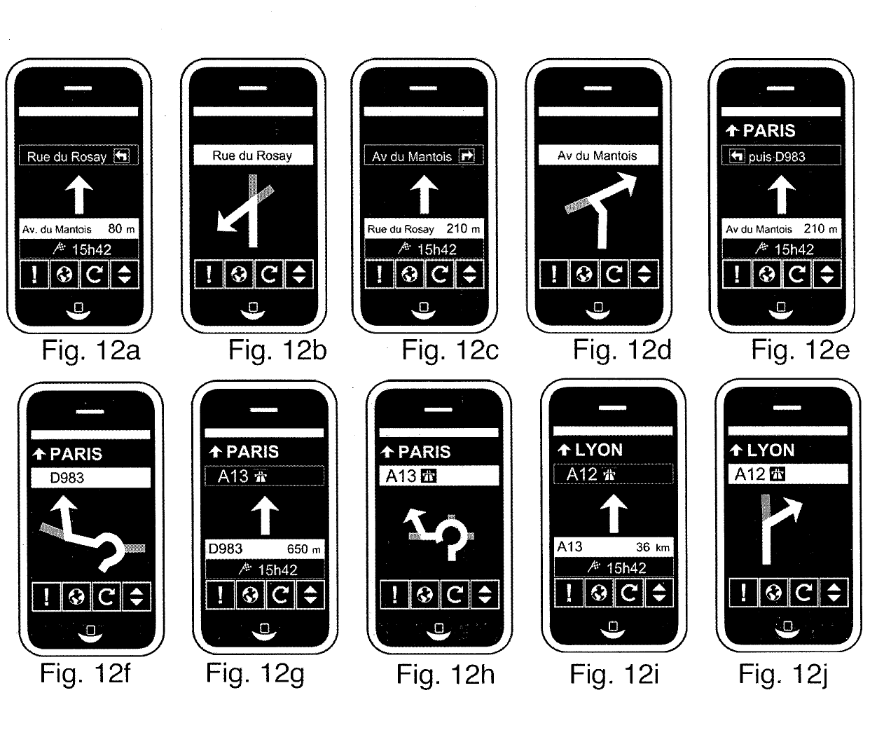

FIGS. 12 to 14 show an alternative embodiment in which the detailed schematic representations of the manoeuvres to be performed are interleaved between the windows presented in the example shown in FIGS. 10 and 11. This example enables the forthcoming manoeuvres to be clearly visualised in order to avoid any error in following the route without the driver having to be subjected to a stream of information likely to distract him or cause difficulties of interpretation.

In all of these examples, the windows are of a fixed or movement-free type, i.e. the displayed content does not move on the screen according to the progression of the mobile device along the route.

The figures and their descriptions given above illustrate rather than limit the invention. In particular, the invention and its different alternatives have just been described in relation to a particular example in which the mobile device is integrated into a portable telephone of the “Smartphone” type.

Nevertheless, it is obvious to a person skilled in the art that the invention can be extended to other embodiments in which, as alternatives, the mobile device is integrated into a road vehicle, as a dashboard equipment element.

The reference numbers in the claims have no limiting character. The verbs “include” and “comprise” do not exclude the presence of elements other than those listed in the claims. The word “a/an/one” preceding an element does not exclude the presence of a plurality of such elements.

1. A navigation system provided with a mobile navigation device comprising access to roadmapping data relating to at least one given geographical zone and enabling a plurality of routes to be determined in this zone, at least one microprocessor, at least one working memory, a route calculation module, and furthermore comprising:
a navigation window generation module, enabling the route data to be formatted into a plurality of successive fixed windows, each comprising a continuity indication corresponding to the display of the current road and the distance over which this road must be followed and a continuity change instruction in the form of either direction data to be followed or manoeuvring geometry data;
a window-changing data generation module enabling data to be generated which are capable of permitting an automatic passage from one navigation window to another;
a navigation module, to provide the transmission to the user of the successive navigation windows;
a geolocation module, enabling the real position of the mobile navigation device to be determined during the movement of the latter;
a matching module, enabling a correspondence to be established between the real position supplied by the geolocation module and the intended route; and
a window-changing module, enabling the passage from one window to another according to window-changing data.

2. The navigation system of claim 1, wherein the window-changing data generation module determines, for each window, at least one window-changing point capable of being recognised during the progression along the route.

3. The navigation system of claim 2, wherein the window-changing point corresponds to a geolocation point.

4. The navigation system of claim 1 comprising a centralised server having access to roadmapping data relating to at least one given geographical zone and enabling a plurality of routes to be determined in this zone, and a plurality of mobile navigation modules, capable of communicating at least temporarily with the central server to exchange data, wherein the digital roadmapping data are retained in the server.

5. The navigation system of claims 4, wherein the route calculation module, the navigation window generation module and the window-changing data generation module are provided in the server.

6. The navigation system of claim 1, furthermore comprising a direction data availability testing module in order to check, for each identified manoeuvring point whether direction-following data are provided in the available roadmapping data.

7. A navigation method for a navigation system comprising at least one mobile navigation device and having access to digital roadmapping data relating to at least one given geographical zone and enabling a plurality of routes to be determined in this zone, comprising the following steps:
receiving data enabling a route to be determined;
calculating, with the aid of a route calculation module and mapping data of at least one zone, at least one route on the basis of the received data; and
arranging, with the aid of a navigation window generation module, the route data into a plurality of successive fixed windows, each comprising a continuity indication corresponding to the display of the current road and the distance over which this road must be followed and a continuity change instruction in the form of either direction data to be followed or manoeuvring geometry data;
displaying, with the aid of a display module of the mobile navigation device, the successive navigation windows.

8. The navigation method of claim 7, wherein the successive navigation windows are displayed according to the real position of said device.

9. The navigation method of claim 7, wherein at least one window-changing datum is provided for each of the navigation windows in order to display the window in relation to the current position of the mobile concerned.

10. The navigation method of claim 7, wherein an instruction includes a direction datum to be followed or a manoeuvring pattern.

11. The navigation method of claims 7, wherein, if a direction datum exists in the mapping data, the instruction comprises the direction datum, otherwise the instruction comprises a manoeuvring pattern.

12. The navigation method of claims 7, wherein the windows comprise a schematic representation of the route portion corresponding to the window.

13. The navigation method of claims 7, wherein the navigation system comprises at least one centralised server and a plurality of mobile navigation devices, capable of communicating at least temporarily with the central server in order to exchange data.

14. The navigatin method of claim 13, wherein the digital roadmapping data are retained in the centralised server.

15. The navigation method of claims 13, wherein the route calculation, navigation window generation and window-changing data generation steps are provided in the centralised server with dispatch to the mobile navigation device concerned, using the data exchange modules, of the navigation window data and possible window-changing data.

16. A computer program product intended to be loaded into a memory associated with a processor, the computer program product comprising portions of software code carrying out the method of claims 7 when the program is run by the processor.

17. A navigation method for a navigation system, comprising at least one mobile navigation device and having access to digital roadmapping data relating to at least one given geographical zone and enabling a plurality of routes to be determined in this zone, comprising the following steps:
receiving data enabling a route to be determined;
calculating, with the aid of a route calculation module and mapping data of at least one zone, at least one route on the basis of the received data;
arranging, with the aid of a navigation window generation module, the route data into a plurality of successive fixed windows; and
displaying, with the aid of a display module of the mobile navigation device, the successive navigation windows,
wherein a window-changing data generation module generates data which are capable of permitting an automatic passage from one navigation window to another according to the real position of said device and wherein, into the plurality of successive fixed windows, each one comprises a continuity indication corresponding to the display of the current road and the distance over which this road must be followed and a continuity change instruction in the form of either direction data to be followed or manoeuvring geometry data.

18. The navigation method of claim 17, wherein the data relating to the continuity indication, the given distance and the route-following instruction are advantageously arranged or formatted in such a way that the display of these data takes up the largest portion of the display space available on the display screen.
